(19) United States
(12) Patent Application Publication
(10) Pub. No.: US 2022/0042824 A1
(43) Pub. Date: Feb. 10, 2022

(54) SYSTEMS, AND METHODS FOR MERGING DISJOINTED MAP AND ROUTE DATA WITH RESPECT TO A SINGLE ORIGIN FOR AUTONOMOUS ROBOTS

(71) Applicant: Brain Corporation, San Diego, CA (US)

(72) Inventors: Sahil Dhayalkar, San Diego, CA (US); Oleg Sinyavskiy, San Diego, CA (US)

(21) Appl. No.: 17/411,466

(22) Filed: Aug. 25, 2021

Related U.S. Application Data
(63) Continuation of application No. PCT/US20/20322, filed on Feb. 28, 2020.
(60) Provisional application No. 62/811,813, filed on Feb. 28, 2019.

(51) Int. Cl. G01C 21/00; B60W 60/00

(52) U.S. Cl. CPC G01C 21/3859; B60W 60/0011; G01C 21/005

(57) ABSTRACT

Systems and methods for detecting merging for merging disjointed map and route data with respect to a single origin for autonomous robots are disclosed herein. According to at least one non-limiting exemplary embodiment, a method for redefining a first route, comprising a first origin point and a plurality of state points defined with respect to the first origin, with respect to a second origin point is disclosed herein.

### PRIORITY

This application is a continuation of International Patent Application No. PCT/US20/20322 filed Feb. 28, 2020 and claims the benefit of U.S. Provisional Patent Application Ser. No. 62/811,813 filed on Feb. 28, 2019 under 35 U.S.C. § 119, the entire disclosure of each are incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods for merging disjointed map and route data with respect to a single origin for autonomous robots.

### Background

Currently, many robots operate autonomously within environments by following learned or preprogramed routes stored in a memory. In order to define a route on a map, an origin point must be determined to provide a base reference point for state parameters of the robot as it navigates the route and localizes objects sensed within the environment. In some instances, multiple robots may operate within a single large environment, thereby requiring the use of many base stations, or starting points, to define origins of a plurality of routes.

Data collected by the robots may be of use to humans. For example a store owner may want to request route data from all robots within the store to view their movement, task performance, etc. Use of a plurality of base stations and corresponding points of origin may lead to difficulty when generating a single map of an environment as each route has its own origin defined about a respective base station. Additionally, robots may be requested to navigate from a first route to a second route, wherein the two routes may begin at separate base stations. This may be difficult for the robots as both routes start at an origin (e.g., point (x=0, y=0)) according to localization data of the two routes stored in its memory.

Accordingly, there is a need in the art for improved systems and methods for redefining a plurality of routes about a unique origin point for autonomous robots such that autonomous robots may localize a plurality of different routes, each with potentially different origins, with respect to a single origin point.

### SUMMARY

The foregoing needs are satisfied by the present disclosure, which provides for, inter alia, systems and methods for merging disjointed map and route data with respect to a single origin for autonomous robots.

Exemplary embodiments described herein have innovative features, no single one of which is indispensable or solely responsible for their desirable attributes. Without limiting the scope of the claims, some of the advantageous features will now be summarized.

According to at least one non-limiting exemplary embodiment, a method for merging multiple routes by a robotic device is disclosed. The method may comprise navigating the robotic device along a global route to generate a global route key defined with respect to a first origin, the global route comprising at least a second origin point of a second route and localization data of objects nearby the second route; defining, relative to the first origin, a starting orientation of the robotic device at the second origin point of the second route; and generating a new route key by applying a linear transformation to a second route key of the second route based on the determined position and orientation of the second origin point, the new route key comprising route data of the second route defined with respect to the first origin. The method may further comprise determining discrepancies between localization of objects between the global route key and the new route key and applying a scan match linear transformation based on the discrepancies of the new route key. The method may further comprise generating a computer-readable map of an environment comprising a plurality of routes defined by the first origin, the plurality of routes being generated by a plurality of corresponding route keys defined about the first origin.

According to at least one non-limiting exemplary embodiment, a robotic device is disclosed. The robotic device may comprise a non-transitory computer-readable storage medium comprising a plurality of computer-readable instructions embodied thereon and a at least one processing device configurable to execute the instructions to: generate a global route key during navigation of a global route, the global route being defined from a first origin and comprising at least a second origin point of a second route and a portion of an environment that the second route comprises; define, relative to the first origin, a starting orientation of the robotic device and the second origin point of the second route; and generate a new route key by applying a linear transformation to a second route key of the second route based on the determined position and orientation of the second origin point, the new route key comprising route data of the second route redefined with respect to the first origin. The at least one processing device or processor of the robotic device may further be configurable to determine discrepancies between localization of objects between the global route key and the new route key and apply a scan match linear transformation based on the discrepancies to the localization data of the new route key. The at least one processor or processing device of the robotic device may further be configurable to generate a computer-readable map of an environment comprising routes defined by the global route key and new route key, wherein route data stored within each key is defined about the origin of the global route.

According to an example embodiment, a method for merging multiple maps is disclosed. The method may comprising merging a first map and a second map to form a single global map, the global map representing first and second routes traveled by one or more robotic devices, wherein, the first map comprising the first route and object localization data, the first route and the localization data are collected by one or more sensors on a first respective robotic device while traveling along the first route, and the second map comprising the second route and object localization data, the second route and object localization data are collected by one or more sensors on a second respective robotic device while traveling along the second route. Wherein the second route is different from the first route and traveled independent of the first route. The method may further comprise, transforming the first and second maps prior to the merging of the first and second maps to form the global map, the transformation of the first and second maps being with respect to a global route. Wherein the global route comprises a plurality of state points defined with respect to an origin of a base in an environment traveled by the robotic device. And, wherein the merging of the first and second maps is performed by a server external to the robotic device.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a,” “an,” and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a main robot in accordance with some embodiments of this disclosure.

FIG. 1B is a functional block diagram of a controller in accordance with some embodiments of this disclosure.

FIG. 2 illustrates a top view of an environment comprising three routes defined about three separate origins located at three corresponding base stations, according to an exemplary embodiment.

FIG. 3 illustrates a robot navigating a global route throughout its environment, according to an exemplary embodiment.

FIG. 4 illustrates a graphical user interface (GUI) prompting a user to input a location of a second base station and starting orientation of a robot at the second base station, according to an exemplary embodiment.

FIG. 5 illustrates an exemplary data table of route data comprising a plurality of state points to be transformed with respect to a new origin, according to an exemplary embodiment.

FIG. 6A-D illustrates a robot performing laser scan matching to correct for user errors generated due to user input of a starting direction and orientation, according to an exemplary embodiment.

FIG. 7 is a process flow diagram illustrating a method for a controller of a robot to redefine a first origin of a route to a new origin of a global route, according to an exemplary embodiment.

FIG. 8 illustrates an exemplary base station in accordance with some embodiments of this disclosure.

FIG. 9A-D illustrates the method of FIG. 7 for aligning at least one disjointed map with a global map, according to an exemplary embodiment.

All Figures disclosed herein are ©Copyright 2018 Brain Corporation. All rights reserved.

### DETAILED DESCRIPTION

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for merging disjointed map and route data with respect to a single origin for autonomous robots. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAYS®, etc.), stocking machines, trailer movers, vehicles, and the like. Robots may also include any autonomous and/or semi-autonomous machine for transporting items, people, animals, cargo, freight, objects, luggage, and/or anything desirable from one location to another.

As used herein, a route based about a base station may comprise a route comprising a plurality of state points defined about an origin located at the base station, each of the plurality of state points comprising state data (e.g., X-Y position and Theta orientation) for a robot to navigate in accordance with the route. For example, a route based about a first base station may comprise a plurality of state points along the route, wherein positional coordinates of each of the state points are defined with respect to an origin (i.e., point (0,0,0)) located at the first base station. A robot navigating this route may navigate such that its position and orientation matches the state point data thereby causing the robot to follow the route.

As used herein, a route key may comprise, for example, a memory pointer, encrypted key, or similar storage method for storing and accessing data corresponding to a route. A route key may be utilized by a controller or processor to access positional state data of the robot as it navigates along a route (e.g., (x, y, θ) position), corresponding time derivatives (e.g., linear and/or angular velocity), state parameters of features of a robot (e.g., ON/OFF states), localization of objects detected along the route, and/or any other parameter detectable by a sensor on a robot stored in a computer readable storage medium during navigation of the route by the robot. It is appreciated that phrases such as “stored within a route key” may correspond to the data of which the route key points to in memory and/or decrypts using an encrypted key. Route data corresponding to a route key may further comprise localization data of sensed objects detected during navigation of a respective route. That is, a route key may store data corresponding to a path of a robot (e.g., a pose graph), a map of an environment sensed by sensors of the robot, or a combination thereof.

As used herein, a state point may comprise pose data for a robot to follow at a designated point along a route such that executing a plurality of poses sequentially from a series of sequential state points along the route may configure the robot to follow the route (i.e., a pose graph). Pose data may include X-Y coordinate positions on a 2-dimensional computer-readable map and an orientation angle theta. In some instances, pose data may comprise any (x, y, z, yaw, pitch, roll) pose parameters if a robot operates and maps its environment in 3-dimensional space. Additionally, state points may include other parameters useful for a robot to execute the route including, but not limited to, linear/angular velocity, states of features of a robot (e.g., ON/OFF states), poses of features of a robot (e.g., pose for a robotic arm attached to a robot), and/or tasks to perform at designated state points (e.g., sweep area around state point N).

As used herein, an origin point may comprise a location defined on a 2-dimensional computer-readable map at a coordinate position of (x=0, y=0). Additionally, an origin point may further comprise a reference direction or angle from which an angular pose of 0° of a robot may be defined with respect thereto. That is, an origin point may define a coordinate and angular position of (x=0, y=0, θ=0°).

As used herein, a map of an environment may comprise a computer-readable map stored within a non-transitory storage medium representing objects sensed within an environment using one or more sensors of a robot. Maps may further comprise corresponding routes through the environment. Maps of environments, or portions thereof, may be accessed using keys similar to route keys. Although the present disclosure mainly references merging multiple routes about a single origin, substantially similar systems and methods may be applied to transform multiple maps of an environment about a single origin such that all objects within the environment may be localized with respect to the single origin.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, LTE/LTE-A/TD-LTE/TD-LTE, GSM, etc.), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, processing device, microprocessor, and/or digital processor may include any type of digital processing device such as, without limitation, digital signal processors (“DSPs”), reduced instruction set computers (“RISC”), general-purpose (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, specialized processors (e.g., neuromorphic processors), and application-specific integrated circuits (“ASICs”). Such digital processors may be contained on a single unitary integrated circuit die or distributed across multiple components.

As used herein, computer program and/or software may include any sequence or human or machine-cognizable steps that perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) define a plurality of different routes within an environment with respect to a single origin; (ii) improve user interaction with robots by providing accurate map data to the user formed by multiple robots; (iii) improve the ability of robots to switch autonomously between different routes located at different locations within an environment; (iv) and minimize risk of operating a robot in complex environments by providing accurate global localization of routes and objects within an environment. Other advantages are readily discernible by one having ordinary skill in the art given the contents of the present disclosure.

According to at least one non-limiting exemplary embodiment, a method for merging multiple routes by a robotic device is disclosed. The method may comprise navigating the robotic device along a global route to generate a global route key defined with respect to a first origin, the global route comprising at least a second origin point of a second route and localization data of objects nearby the second route; defining, relative to the first origin, a starting orientation of the robotic device at the second origin point of the second route; and generating a new route key by applying a linear transformation to a second route key of the second route based on the determined position and orientation of the second origin point, the new route key comprising route data defined with respect to the first origin. The method may further comprise determining discrepancies between localization of objects between the global route key and the new route key and applying a scan match linear transformation based on the discrepancies to the new route key. The method may further comprise generating a computer-readable map of an environment comprising a plurality of routes defined by the first origin, the plurality of routes being generated by a plurality of corresponding route keys defined about the first origin.

According to at least one non-limiting exemplary embodiment, a robotic device is disclosed. The robotic device may comprise a non-transitory computer-readable storage medium comprising a plurality of computer-readable instructions embodied thereon and an at least one processor configured to execute the instructions to: generate a global route key during navigation of a global route, the global route being defined from a first origin and comprising at least a second origin point of a second route and a portion of an environment that the second route comprises; define, relative to the first origin, a starting orientation of the robotic device and the second origin point of the second route; and generate a new route key by applying a linear transformation to a second route key of the second route based on the determined position and orientation of the second origin point, the new route key comprising route data of the second route redefined with respect to the first origin. The at least one processor of the robotic device may further be configured to determine discrepancies between localization of objects between the global route key and the new route key and apply a scan match linear transformation based on the discrepancies to the localization data of the new route key. The at least one processor of the robotic device may further be configured to generate a computer readable map of an environment comprising routes defined by the global route key and new route key, wherein route data stored within each key is defined about the origin of the global route.

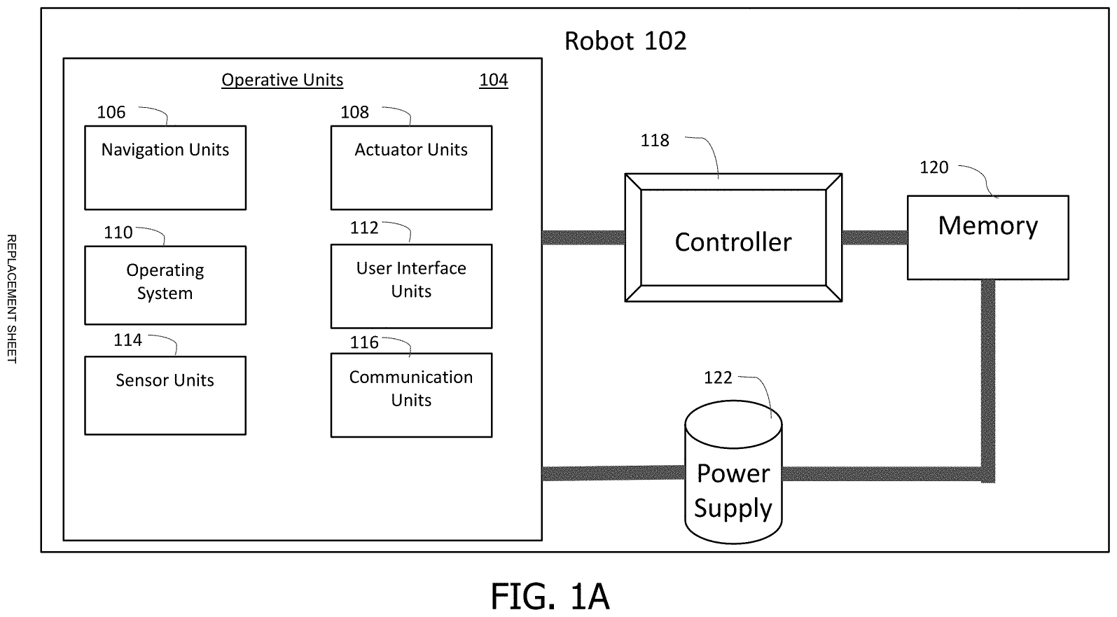

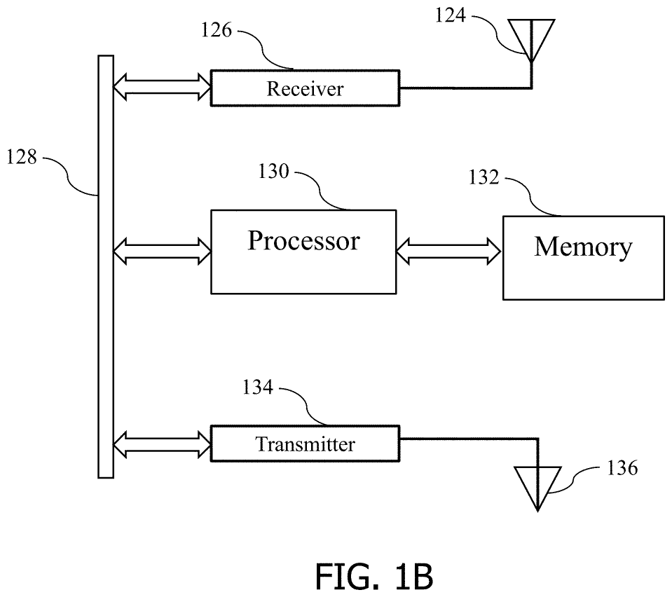

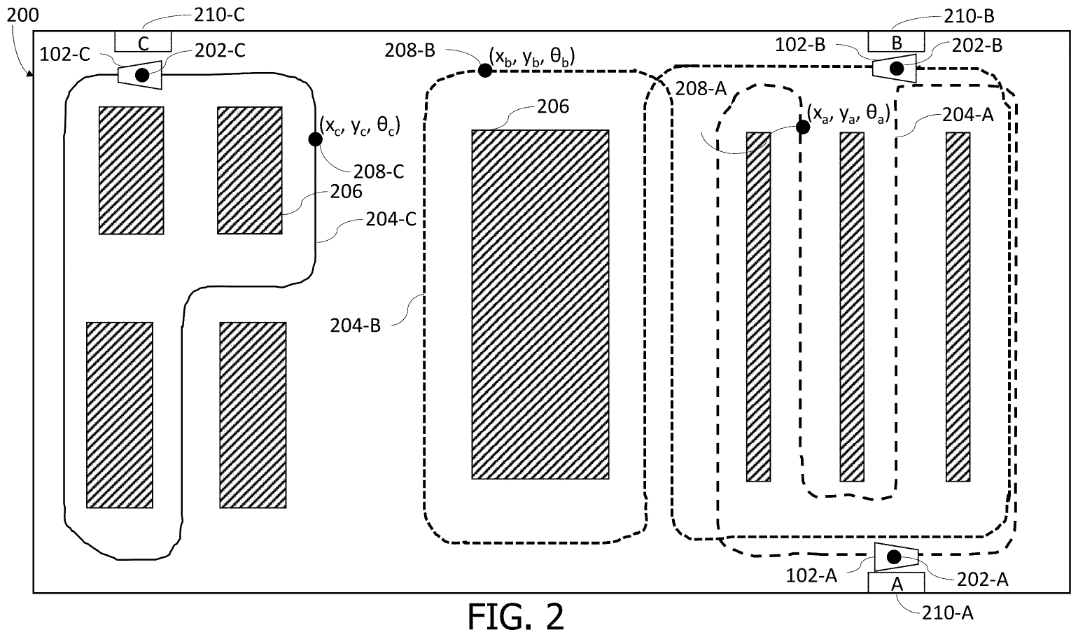

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processors or processing devices (e.g., microprocessors) and other peripherals. As previously mentioned and used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, specialized processors (e.g., neuromorphic processors), and application-specific integrated circuits (“ASICs”). Such digital processors may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processor or a processing device may be external to robot 102 and be communicatively coupled to controller 118 of robot 102 utilizing communication units 116 wherein the external processor may receive data from robot 102, process the data, and transmit computer-readable instructions back to controller 118. In at least one non-limiting exemplary embodiment, the processor or processing device may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processors or processing devices. In some embodiments, a single controller (e.g., controller 118) may serve as the various controllers and/or processors described. In other embodiments different controllers and/or processors may be used, such as controllers and/or processors used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units that provide the various functionality of robot 102. In exemplary embodiments, operative units 104 may be instantiated in software, hardware, or both software and hardware. For example, in some cases, units of operative units 104 may comprise computer-implemented instructions executed by a controller. In exemplary embodiments, units of operative unit 104 may comprise hardcoded logic. In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magnetostrictive elements, gesticulation, and/or any way of driving an actuator known in the art. By way of illustration, such actuators may actuate the wheels for robot 102 to navigate a route; navigate around obstacles; rotate cameras and sensors.

Actuator unit 108 may include any system used for actuating, in some cases to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art. According to exemplary embodiments, actuator unit 108 may include systems that allow movement of robot 102, such as motorized propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras including video cameras (e.g., red-blue-green (“RBG”) cameras, infrared cameras, three-dimensional (“3D”) cameras, thermal cameras, etc.), time of flight (“TOF”) cameras, structured light cameras, antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3GPP/3GPP2), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used here on out, a robot 102, a controller 118, or any other controller, processor, or robot performing a task illustrated in the figures below comprises a controller executing computer-readable instructions stored on a non-transitory computer-readable storage apparatus, such as memory 120, as would be appreciated by one skilled in the art.

Next referring to FIG. 1B, the architecture of the controller 118 used in the system shown in FIG. 1A is illustrated according to an exemplary embodiment. As illustrated in FIG. 1B, the architecture includes a data bus 128, a receiver 126, a transmitter 134, at least one processor or processing device 130, and a memory 132. The receiver 126, the processor or processing device 130 and the transmitter 134 all communicate with each other via the data bus 128 which may be illustrative of one or more data channels or wire connections (e.g., a memory-mapped bus). The processor or processing device 130 is configured to access the memory 132, which stores computer code or instructions in order for the processor or processing device 130 to execute the specialized algorithms. As illustrated in FIG. 1B, memory 132 may comprise some, none, different, or all of the features of memory 124 previously illustrated in FIG. 1A. The algorithms executed by the processor or processing device 130 are discussed in further detail below. The receiver 126 as shown in FIG. 1B is configured to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing by the specialized controller 118. The receiver 126 communicates these received signals to the processor or processing device 130 via the data bus 128. As one skilled in the art would appreciate, the data bus 128 is the means of communication between the different components—receiver, processor, and transmitter—in the specialized controller 118. The processor or processing device 130 executes the algorithms, as discussed below, by accessing and executing in a specific way the computer-readable instructions from the memory 132. Further detailed description as to the processor or processing device 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor or processing device 130 may communicate output signals to transmitter 134 via data bus 128 as illustrated. The transmitter 134 may be configured to further communicate the output signals to a plurality of operative units 104 illustrated by signal output 136 via wired or wireless communication.

One of ordinary skill in the art would appreciate that the architecture illustrated in FIG. 1B may illustrate an external server architecture configured to effectuate the control of a robotic apparatus from a remote location. That is, the server may also include a data bus, a receiver, a transmitter, a processor, and a memory that stores specialized computer-readable instructions thereon.

FIG. 2 is a top view of a store 200 comprising three base stations 210-A, 210-B, and 210-C and three routes 204-A, 204-B, and 204-C, each route beginning at a respective base station, according to an exemplary embodiment. As illustrated, each robot 102 may start a route 204 near a corresponding base station 210 at a point 202 and complete the route at the same base station 210, thereby creating closed loop routes. Each of these routes 204 may comprise a plurality of state points 208 denoting positions and state parameters (e.g., X-Y position, angle, velocity, etc.) of a robot 102 at discrete points along the routes 204, wherein only a few state points 208 have been illustrated for clarity. Additionally, each of these routes 204 may be defined about an origin located at corresponding points 202 (e.g., state points 208-A of route 204-A may be defined about an origin located at point 202-A). A robot 102 may store a route key in memory 120 comprising the state points 208 of a route 204 as well as localization data of nearby objects 206, tasks to perform at locations, and/or any other additional route information collected by the robot 102 during navigation of a respective route 204.

A robot 102 navigating any route 204 may, upon completion of the route 204, generate a route key. The route key may comprise, for example, a memory pointer, encryption key, or other method of storing route data (i.e., state point data of pose graphs) and computer-readable map data (i.e., objects detected using sensor units 114) in a memory 120 of the robot 102. The route key, however, may only comprise route and map data of which the robot 102 has navigated and sensed. Route keys may further comprise time stamps or associated time data corresponding to a time when the robot 102 executed the route and generated the computer-readable map. Route keys corresponding to a same route (e.g., 204-C) may be stored in a memory, whereby the time data associated thereto may be utilized by one or more robots 102 executing the same route at later times to provide accurate and up-to-date route and map data.

In some instances, it may be beneficial to define all routes 204-A, 204-B, and 204-C with respect to a single origin point such that, for example, a global map of all routes and state points may be generated and defined with respect to the single origin. For example, an owner of the store 200 may desire to view all routes 204 on a single map of the store 200 thereby requiring all routes 204 to be defined about a single base station 210 to minimize errors associated with simply superimposing different routes 204 upon a single map. Although the present disclosure describes systems and methods for defining routes 204-B and 204-C with respect to an origin located at a point 202-A of base station 210-A, substantially similar methods may be utilized to define any route 204 with respect to an origin located at a separate base station, wherein defining routes 204-B and 204-C with respect to point 202-A is not intended to be limiting. It is appreciated that a plurality of state points 208 may be defined along corresponding routes 204, wherein only one state point 208 has been illustrated per route for clarity.

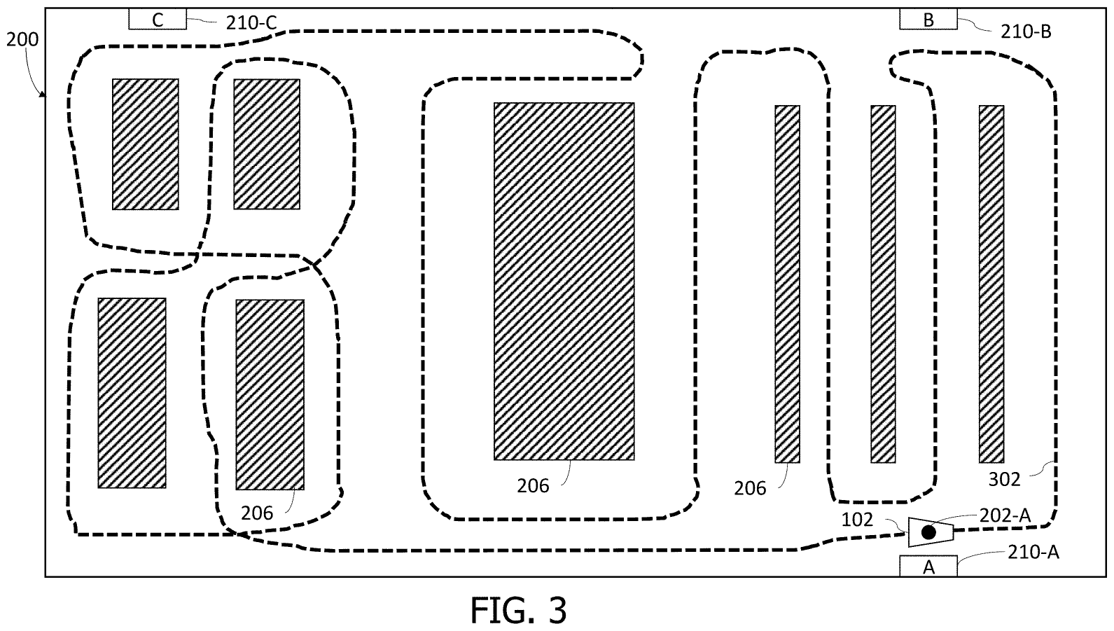

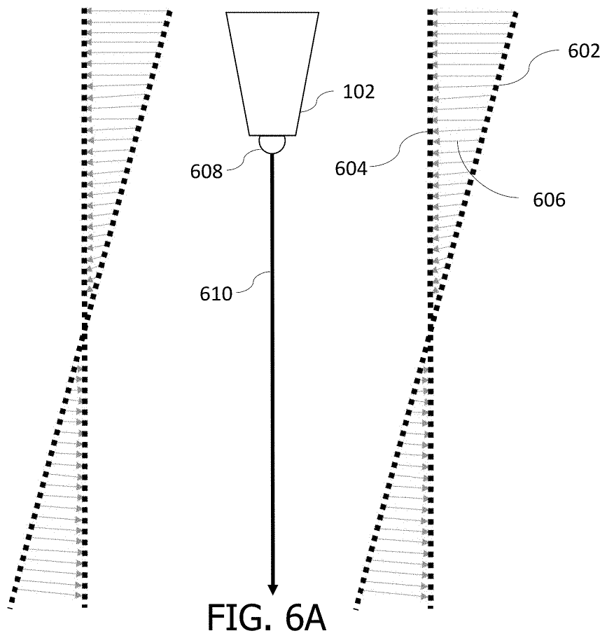

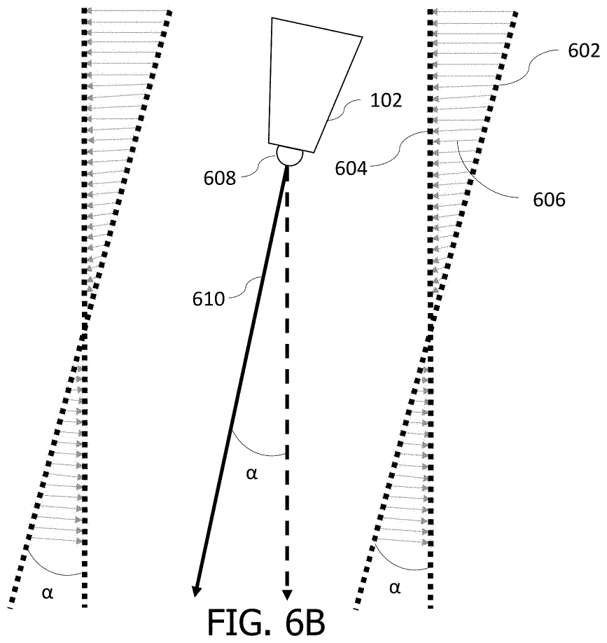

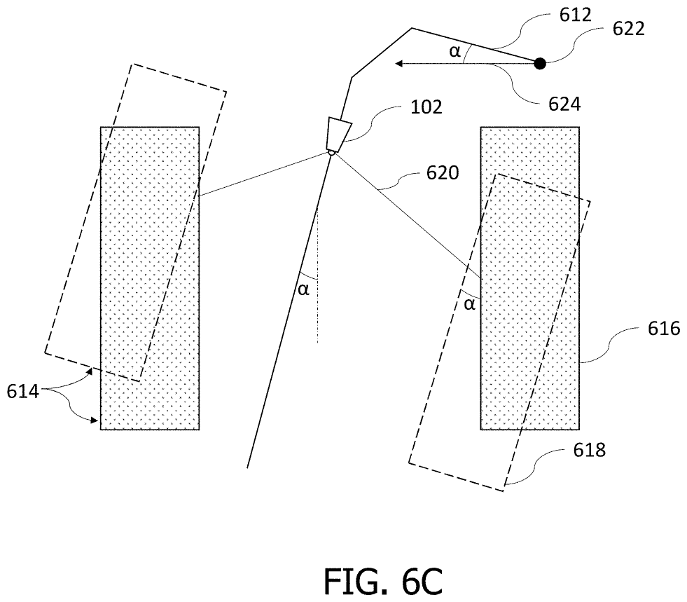

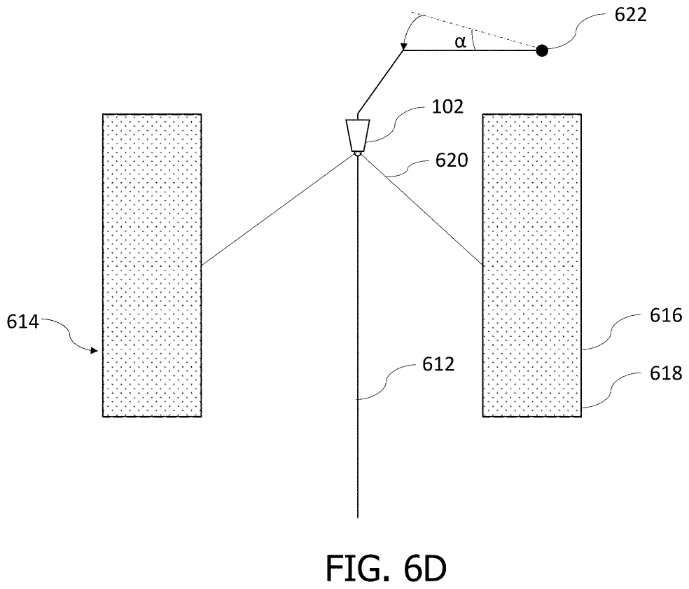

To generate a single map of all routes, routes 204-B and 204-C may first be defined about a single origin point such as point 202-A. A global route 302, illustrated next in FIG. 3, may be navigated by an operator maneuvering a robot 102 throughout the entire environment 200 beginning at the point 202-A. It is appreciated that route 204-A is already defined about the origin point 202-A and may therefore require no transformation. FIG. 3 illustrates an exemplary global route 302 within the store 200 illustrated above in FIG. 2, according to an exemplary embodiment. Robot 102 may begin navigation of the global route 302 from an origin point 202-A, wherein point 202-A may serve as an origin point from which state points 208-B and 208-C of routes 204-B and 204-C may be redefined with respect thereto. Creating the global route 302 may comprise navigating the robot 102 in a route learning mode or discovery mode around the entire store 200, between each obstacle 206, and nearby each base station 210-B and 210-C such that the entirety of both routes 204-B and 204-C are encompassed in the global route (i.e., all detectable objects and base stations of the routes 204-B and 204-C have been localized during navigation of the global route 302). The global route 302 is not required to follow the respective routes 204-B and 204-C exactly, rather the objects 206 sensed by sensor units 114 during navigation of the routes 204-B and 204-C are required to be sensed by the robot 102 during the navigation of the global route 302. That is, global route 302 may, at a minimum, include sensor units 114 detecting objects 206 which are detected during navigation of routes 204-B and 204-C. It is appreciated that a plurality of different global routes 302 may be navigated such that the above requirements are satisfied, wherein the global route 302 illustrated is not intended to be limiting. During navigation of the global route 302, all sensor data from sensor units 114 may be stored in memory 120 as the sensor data may be utilized to verify transformations, as illustrated in FIG. 6A-D below. Upon completion of the global route 302, the robot 102 may be returned to point 202-A such that the global route 302 comprises a closed loop path and the robot 102 may exit the global route mode. All data collected during navigation of the global route 302 (e.g., localization data of objects 206, base stations 202-B and 202-C, parameters of the objects 206 such as color or saliency, etc.) may be stored in memory 120 and accessed and/or modified using a global route key.

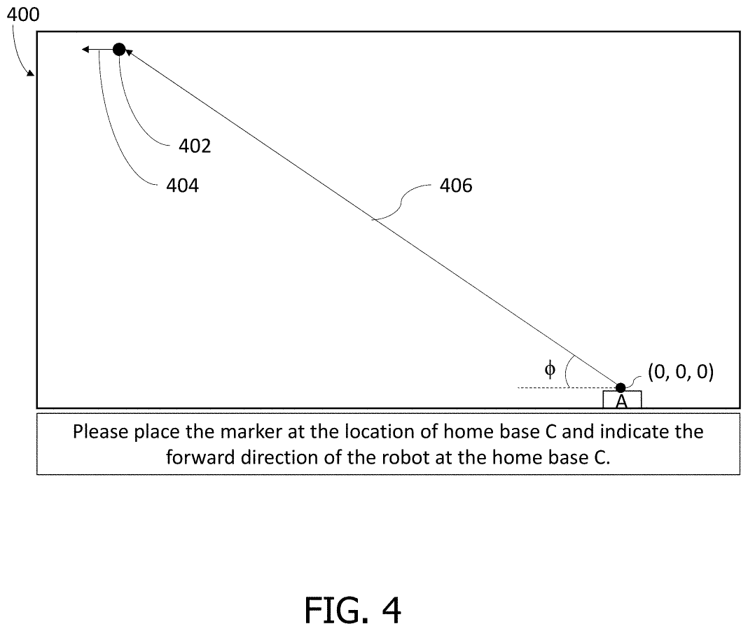

During navigation of the global route 302, a controller 118 of the robot 102 may (i) track the position of the robot 102 (e.g., in a pose graph defined with respect to origin 202-A) and (ii) map objects 206 onto a computer-readable map. This, in turn, creates a single map of at least the entire environment encompassed by the other two routes 204-B and 204-C. Subsequent navigation of the routes 204-B or 204-C, however, still requires a controller 118 to localize objects and its position with respect to a respective origin 202-B and 202-C, thereby creating disjointed maps (i.e., separate maps for portions of environment 200, each defined with respect to a different origin). Accordingly, the foregoing disclosure provides systems and methods for merging these disjointed maps into a single global map using data collected, in part, during navigation of the global route 302 and from a user, as illustrated in FIG. 4 next. The disjointed maps may be created prior to or after navigation of the global route 302.

According to at least one non-limiting exemplary embodiment, a route 204 may not comprise a closed loop wherein a closed loop may be determined by closing the loop via a reverse path (i.e., the loop is closed by simulating the robot 102 navigating backwards along the non-closed loop path).

According to at least one non-limiting exemplary embodiment, a global route 302 may be generated by a robot 102 in an exploration mode. For example, the robot 102 may begin at point 202-A and autonomously explore (e.g., using an area fill algorithm, random walk, etc.) the environment whilst collecting sensor data of, for example, localized objects 206 within the environment.

FIG. 4 illustrates a graphical user interface (GUI) 400 prompting an operator of the robot 102 (e.g., the operator navigating the robot 102 through global route 302) to locate a location 402 of a start point 202-C of a corresponding base station 210-C on a computer-rendered map, according to an exemplary embodiment. The display on the GUI 400 is produced using, in part, data collected during navigation of the global route 302. In addition to the operator locating the position 402 of the start point 202 on the map, the operator may be prompted to indicate a forward direction of the robot 102 at the location 402. It is appreciated that a similar display on the GUI 400 also may prompt a user to indicate a start position 402 and corresponding starting direction 404 for base B near the top right of the display.

According to at least one non-limiting exemplary embodiment, a robot 102 may be required to pass by a base station in only one direction such that the base station may be localized (i.e., features of the base station may be detected) on one designated side of the robot 102. For example, a robot 102 may be equipped with side cameras such that the robot 102 may be required to pass base stations 210 on the left or right side of the robot 102. According to at least one non-limiting exemplary embodiment, an initial direction of the robot 102 with respect to a starting point 202 may be only defined by an operator on the GUI 400, wherein the robot 102 may pass by the base stations 210 in any direction provided the starting direction 404 is indicated on the GUI 400.

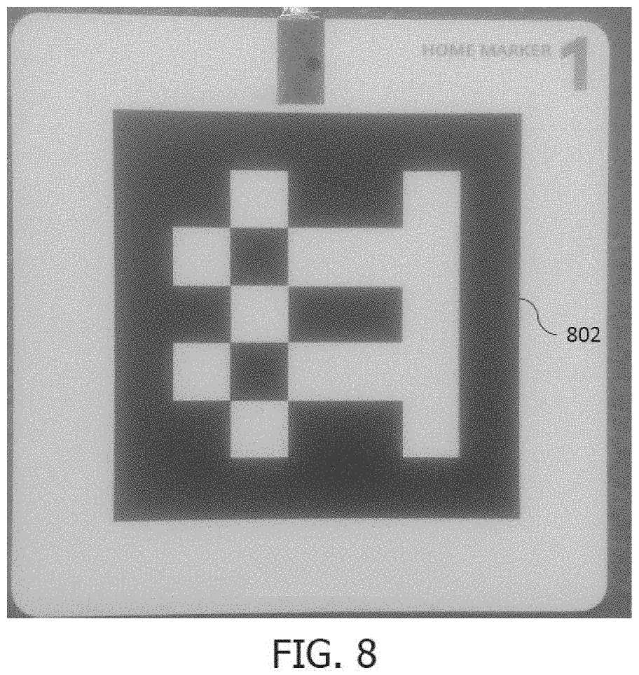

According to at least one non-limiting exemplary embodiment, starting point 402 may be determined during navigation of a global route 302, wherein an operator may only be prompted to input a starting direction 404. This may require the robot 102, during navigation of the global route 302, to pass by and sense a base 210. The base 210 may comprise a marker, landmark, or feature identifiable by sensor units 114, such as the quick response (“QR”) code depicted in FIG. 8 below.

Upon the operator indicating a location 402 and corresponding initial direction 404, a measurement 406 may be determined. Measurement 406 may comprise an (x, y, ϕ) measurement of the distance and angle between the base station 210-A and point 402. The measurement 406 may define a transformation to state points 208 along routes based about base stations 210-B and 210-C, as illustrated below. Angle ϕ is defined with respect to (i) the starting direction of the global route 302, or (ii) a 0° reference angle of origin 202-A. Due to the linearity of the transformations (i.e., a linear shift in coordinates), measurement 406 and data from global route 302 may be sufficient to transform routes 204-B and 204-C, illustrated in FIG. 2, about an origin located at point 202-A. Use of a GUI 400 to determine a point 402 corresponding to a location of a base station 210 based on human input may be inaccurate and prone to human error as inputting the start direction 404 slightly incorrectly (e.g., 5° or more) may cause all state point data of the newly defined route to comprise propagating errors. Accordingly, a scan match transformation may additionally be utilized to correct state points of routes 204-B and 204-C such that the route data (i.e., state point values along the routes) are accurately mapped to the new origin despite the human error as illustrated in FIG. 6A-D below.

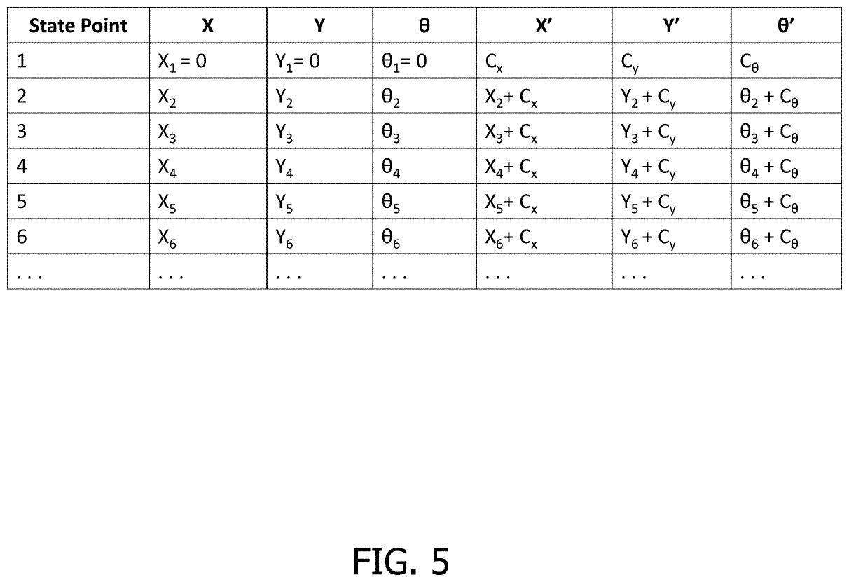

FIG. 5 is a data table comprising a plurality of state points 208 along a route defined about a first base station 210, according to an exemplary embodiment. The data table may be stored in a memory 120 of a robot 102 and accessed using a corresponding route key. Each state point 208 may comprise discrete x, y, and θ values for which a robot 102, upon navigating the route to a corresponding state point 208, must position itself in order to follow the route. A robot 102 may be required to move from a state point N to a subsequent state point N+1, for example, after a set time interval (e.g., every 1 second) during navigation of the route, N being any integer number. State point 1 may comprise the origin 202-B or 202-C of a first base station 210-B or 202-C, respectively, and therefore define the origin of the route prior to a transformation. Accordingly, state point 1 may comprise x₁, y₁, and θ₁ values of zero.

An operator may desire to transform the route shown in the table to redefine the route about a second origin located at a second base station 210-A. Accordingly, the operator may generate a global route 302 beginning at the origin 202-A of the second base station 210-A and, upon completion of the global route 302, input a (i) location 402 of the first base station 210-B or 210-C relative to the second base station 210-A, and (ii) an initial direction 404 on a GUI 400 as illustrated in FIGS. 3-4 above. Upon a controller 118 of the robot 102 determining values for a measurement 406, a linear transformation may be applied to the state values (x, y, θ) in the data table such that the state values are redefined about the second origin 202-A of the second base station 210-A, wherein the new state values are denoted as (x′, y′, θ′). The linear transformation may comprise a shift of the (x, y) coordinates of each state point by a constant value based on the length of measurement 406 and angle ϕ with respect to a starting angle of the global route 302 or 0° angle of origin 202-A. The linear transformation may additionally comprise a linear shift of the θ coordinates of each state point by a constant value based on the angle of measurement 406 (i.e., angle ϕ illustrated in FIG. 4). Constants Cᵢ may be positive, negative, or zero value.

It is appreciated by one skilled in the art that the exemplary data table illustrated in FIG. 5 comprising a plurality of state points 208 may be a self-referential data table wherein rows and/or columns may be added, removed, and/or replaced as the controller 118 executes computer-readable instructions from memory 120.

According to at least one non-limiting exemplary embodiment, state points 208 may comprise additional state data, such as velocity or states of features of a robot 102 (e.g., ON/OFF state of a vacuum feature of a cleaning robot). Accordingly, additional transformations may be applied to the additional state data following a substantially similar transformation.

To access route data stored in the data table, a controller 118 may utilize a corresponding route key. As previously mentioned, a route key may comprise a memory pointer or encrypted key that may point or allow access to a location in memory 120 at which route data (e.g., state points, object localization data, etc.) for the corresponding route key is stored. The controller 118 may access the data using the route key and apply the transformations accordingly. According to at least one non-limiting exemplary embodiment, a new route key is generated upon the first and each subsequent navigation of a route. It is appreciated that the data stored within each of the keys of the same route may be substantially similar, however subsequent keys may be utilized to determine changes in an environment and reduce human error of inputting point 402 and direction 404 onto GUI 400, as illustrated in FIG. 4 above. To reduce the errors, a method of laser scan matching is performed during subsequent navigation of a route as illustrated next in FIG. 6A-D.

It is appreciated that the linearity of the transformations to the (x, y, θ) coordinates illustrated in FIG. 5 occur for an idealized scenario, wherein sensors, odometers, actuators, and other components of a robot 102 comprise no noise and/or biases. One skilled in the art may recognize that some noise and/or biases may occur in measurements of the state parameters of each state point caused by a plurality of nonlinear effects. A plurality of systems and methods are well known within the art to account for and minimize these nonlinear effects, wherein the linearity of the transformations described herein presume the nonlinear effects due to, e.g., biases and noise are negligible.

FIG. 6A illustrates a robot 102 navigating along a route 610 and performing a process of scan matching to reduce errors associated with human input of a starting point 402 and direction 404 into a GUI 400, as illustrated in FIG. 4 above, according to an exemplary embodiment. The human error may comprise incorrect input of the start point 402 and/or incorrect input of the starting direction 404 by a few feet (e.g., within 5 or 10 feet) or degrees (e.g., between 0 and 15 degrees). Route 610 may begin at a base station 210, which does not comprise the origin of a global route but is defined with respect to the origin of the global route. In other words, route 610 may be executed by a robot using transformed data stored in, for example, columns four through seven in the table of FIG. 5 above. Memory 120 of the robot 102 may comprise localization data 602 of the nearby objects collected during navigation of a global route 302 for later comparison with data collected during navigation of route 602 using the scan matching. Accordingly, the localization data 602 is defined about an origin at a start point of desired base station (e.g., 210-A) and not the origin of the route 610. Additionally, each dot of localization data 602 and 604 may illustrate a discretized measurement of a surface of an object measured by individual measurement beams of sensor 608 (e.g., points of a point cloud created by LiDAR measurements or scans).

During the navigation of the route 610 using a transformed route key (i.e., a map and route transformed based on measurement 406), discrepancies 606 in positions of objects may arise. Points 602 may comprise points of a point cloud representing surfaces of objects (e.g., measured using a scanning LiDAR sensor) localized during navigation of the global route 302. Points 604 may comprise points of a point cloud representing surfaces of the same objects localized during navigation of the route 610, the points 604 being defined with respect to an origin of the global route 302. Both points 602, 604 are defined with respect to an origin of the global route 302. The discrepancies 606 arise due to a human error of inputting start point 402 and/or starting direction 404.

A scan matching transformation corresponds to a transformation along (x, y, θ) parameters which causes all points 604 to align with all points 602, or as closely as possible (i.e., minimizing discrepancies 606). This transformation comprises a mathematical operation which, when applied to both route 610 state point data and localization data 604, causes the localization data 604 to align with the global route localization data 602.

In FIG. 6B, a controller 118 of the robot 102 makes an adjustment to the route 610 by an angle α, the angle α being determined based on discrepancies 606 between localization data 602 and 604 and the adjustment being performed by changing state point data in memory 120 using specialized algorithms based on the discrepancies 606 and angle α. The adjustment is not required for navigation of route 610 by a robot 102 if the robot 102 is executing route 610 defined with respect to a local origin of route 610 (i.e., not an origin of the global route 302), however the adjustment is required for localizing the route data with respect to the origin of the global route 302 (e.g., to produce a global map including route 610 and other routes). Upon performing the correction to the route 610, localization data of the nearby objects during subsequent navigation of the corrected route 610 (defined with respect to an origin of a global route 302) may match with localization data 604 obtained during navigation of the global route 302.

According to at least one non-limiting exemplary embodiment, a correction to route 610 based on discrepancies 606 may further comprise a linear and/or trigonometric shift of x-coordinates, y-coordinates, an angular shift (as illustrated in FIG. 6B), or a combination thereof to the route 610.

According to at least one non-limiting exemplary embodiment, an error threshold may be imposed such that discrepancies in measurements 602 and 604 exceeding the threshold may require no correction 606. Use of an error threshold may reduce false error correction caused by changes in an environment (e.g., movement of the nearby objects by a human).

According to at least one non-limiting exemplary embodiment, corrections 606 may be performed based on a root mean square error, or similar error measurement (e.g., L1-norm, L2-norm, etc.), of discrepancies between measurements 604 and 602 across a plurality of scans over a period of time (e.g., 60 scans over one second for a LiDAR sensor sampled at 60 Hz).

Advantageously, the method of laser scan matching illustrated in FIG. 6A-B may drastically reduce human error associated with an input of point 402 and/or direction 404 onto GUI 400, as illustrated in FIG. 4 above, as a robot 102 may utilize discrepancies 606 between localization data 602 and 604 to determine the human error (e.g., angle α, x-y discrepancies, etc.) and correct for the error during future navigation of the route 610. It is appreciated that sufficient error correction may be achieved by scan matching data 602 generated during navigation of a global route 302, defined with respect to a first origin point and beginning nearby a first base station, and a single set of data 604 generated during a subsequent run of a route 610, defined with respect to the first origin and beginning nearby a second base station, to correct for the human error associated with inputs into GUI 400 as discrepancies 606 measured during subsequent navigation of the route 610 may be negligible. Use of scan matching yields an unconventional result in that a human may input a starting point 402 and starting direction 404 into a GUI 400 with some error yet a robot 102 may determine and correct for the error using the method of scan matching. Additionally, use of a plurality of scans of objects along a route may further enhance accuracy of corrections determined by the scan matching as the plurality of scans may form a distributed system of data points corresponding to a plurality of different measurements of objects at different orientations and/or positions of the robot 102.

FIG. 6C illustrates a top view of a robot 102 performing laser scan matching to determine an error angle α caused by incorrect input of direction 404 into GUI 400, according to an exemplary embodiment. The robot 102 may follow a route 612 beginning at start point 622 (determined by input of point 402 on the GUI 400), moving directly leftwards with respect to the page along arrow 624, and executing a 90° turn into a hallway between two objects 614. Route 612 may be defined with respect to an origin of a global route 302 separate from point 622. Accordingly, any measurements herein with respect to FIGS. 6C-D comprise coordinate measurements with respect to an origin at the start location of the global route 302 (not shown). During navigation of a global route 302, the robot 102 may have localized the objects 614 at position 618 (denoted by dashed lines), however, as the robot 102 navigates the route 612 it detects the objects 614 at position 616 (denoted by solid rectangles). Using scans 620 from a sensor (e.g., sensor 608 illustrated in FIG. 6A above), angle α may be determined based on the difference between scans of the objects 614 during the global route 302 and subsequent navigation of route 612. As illustrated, the error angle α may be determined using objects at locations separate from the starting point 622 of the route 612. Accordingly, the value of a may be determined based on trigonometric identities (e.g., complementary and/or supplementary angles as illustrated, wherein all a values shown are equivalent) and the discrepancy between the position 618 and 616 (e.g., discrepancies 606 between scans 604 and 602 illustrated in FIG. 6A above).

Next, FIG. 6D illustrates a corrected route 612 comprising error corrections based on the angle α such that positions 616 and 618 of the object 614 as measured by the robot 102 during navigation of the transformed and corrected route 612 key (i.e., transformed with respect to an origin of the global route 302 separate from point 622 and corrected with respect to angle α) and the global route 302 key, respectively, coincide. The correction may comprise the robot 102 correcting the first state point of the route 612 by an angle α and utilizing trigonometric functions/identities (e.g., cosine, sine, etc.) to determine new X-Y positions and θ orientation of the robot 102 at subsequent state points. The new transformed and corrected route 612 key may now comprise substantially low error due to human input of direction 404 into GUI 400 and additionally comprise all state points of the route 612 key are defined with respect to an origin of the global route 302.

According to at least one non-limiting exemplary embodiment, an error correction using scan matching may additionally comprise a linear shift along x and/or y coordinates. For example, a human may input a start point 402 at a location 1 meter to the left along, e.g., the −x direction, of an actual location of a start point corresponding to a base station. Accordingly, a robot 102 may perform scan matching described herein with respect to FIG. 6A-D to determine the 1 meter error and shift all state point data of the route by 1 meter to the right, e.g., in the +x direction, such that, during subsequent navigation of the route, the robot 102 may localize nearby objects in accordance with an origin of the global route 302.

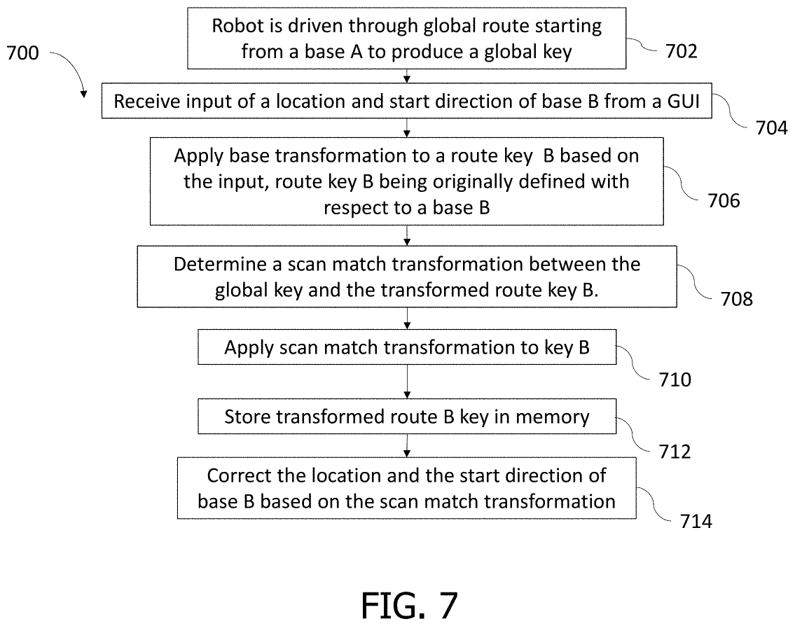

FIG. 7 is a process flow diagram illustrating a method 700 for a controller 118 of a robot 102 to transform a key B, comprising state point data and sensor localization data of a route B defined about an origin B located at or near a base B, with respect to a new origin A located at or near a base A, according to an exemplary embodiment. As used herein with respect to FIG. 7, an origin A may comprise a start point 202 of which a (x=0, y=0) point, or origin, may be defined with respect to a nearby base station 210. Similarly, origin B may comprise a different start point 202 for a corresponding route B, the route B having a corresponding key B which stores, points to, or otherwise represents route and mapping data collected by a robot 102 during navigation of route B.

Block 702 comprises the controller 118 navigating a robot 102 through a global route starting from the base A to produce a global route key. The global route may be navigated in an exploration mode or a training mode under human supervision or guidance. The global route must at least pass nearby the base B and/or detect at least one object sensed by the robot 102 during navigation of routes associated with base B. The global route key comprises a plurality of state points all defined with respect to the origin A of base A and objects localized with respect to the origin A. The global key is stored in a memory 120 upon the global route being completed.

Block 704 comprises the controller 118 receiving input from the operator, the input comprising the operator locating a position 402 of the base B on a computer-readable map displayed on a GUI 400, as illustrated in FIG. 4 above. Additionally, the operator may input a forward starting direction 404 indicating the starting orientation of the robot 102 at base B. In at least one non-limiting exemplary embodiment, during navigation of the global route, the sensor units 114 may detect and localize the starting position 402 of the base B and may only require the starting direction 404 from the operator.

Block 706 comprises the controller 118 applying a transformation to the state points of the route B, route B being originally defined with respect to an origin B at or near the base B, based on the input to the GUI 400. The linear transformation may be based on the inputs 402 and 404 received in block 704 as well as additional measurements derived therefrom (e.g., distance measurement 406 and angle ϕ as illustrated in FIG. 4). Additionally, the transformation may be substantially linear and applied to localization data of objects detected along route B such that the locations of these objects are defined with respect to an origin A at base A. The controller 118 may store the new transformed key B in memory 120 for later error correction using laser scan matching during subsequent navigation of the route B.

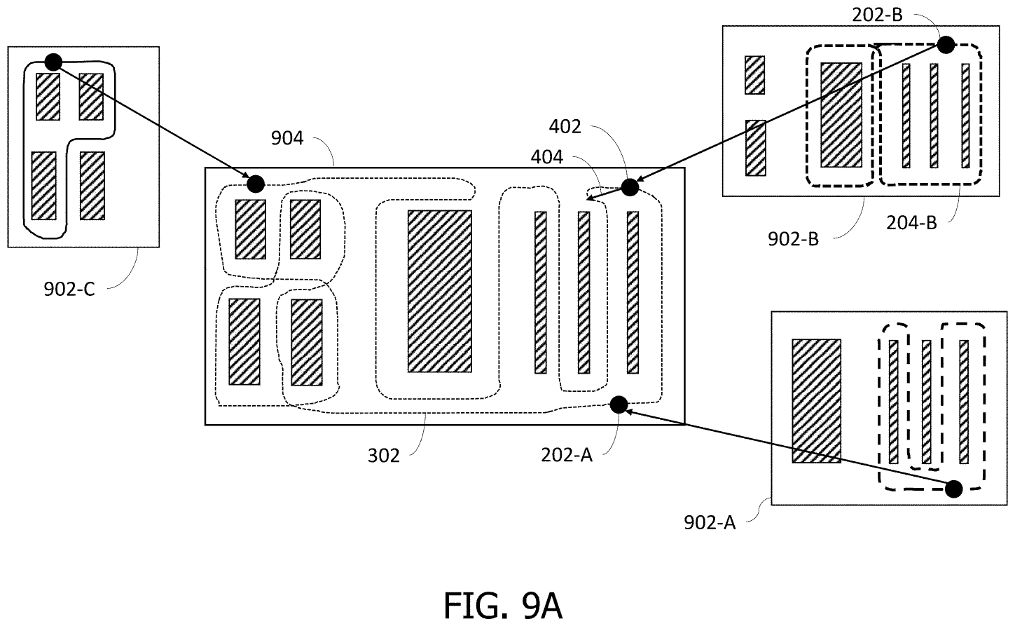

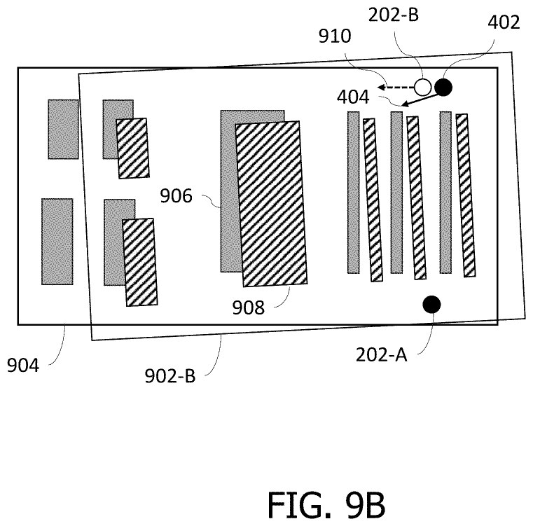

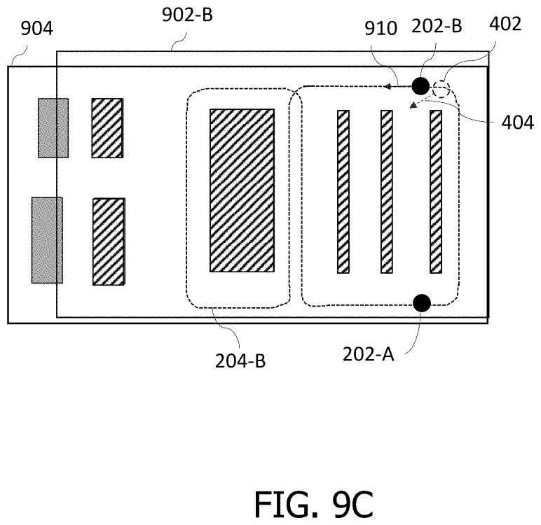

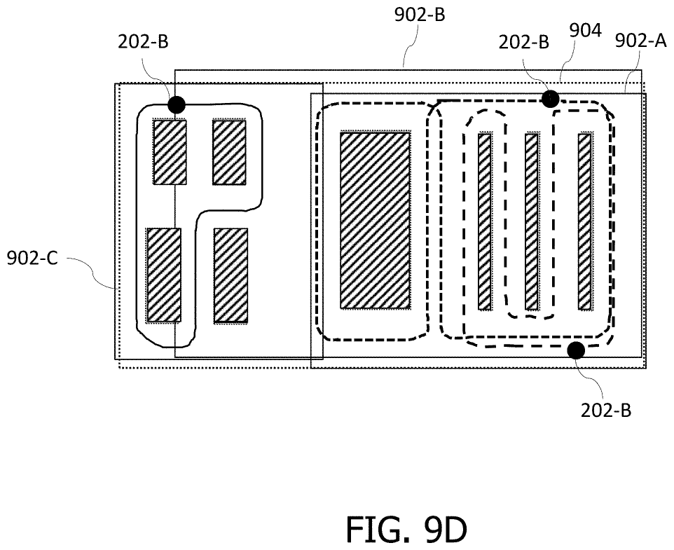

It is appreciated that, although the route key B is now defined with respect to the origin A of base A, however the human error introduced by the input to the GUI 400 may cause mapping errors, as illustrated below in FIG. 9B, as it is difficult for a human to input the starting position 402 and/or direction 404 with perfect accuracy.

Block 708 comprises the controller 118 performing laser scan matching onto the transformed key B, denoted hereinafter as key B′, based on localization data 604 collected during navigation of the route B, wherein the key B′ comprises the original route key B redefined with an origin A at base A. Key B′ may comprise, in part, objects localized in different locations than the global key due to the imperfect user input 402, 404 which may cause discrepancies 606 as shown in FIG. 6A-B and discrepancies shown in FIG. 9B below.

Block 710 comprises the controller 118 applying a scan match transformation based on the above discrepancies 606 between localization of objects in the global key and key B′. The scan match transformation may comprise an angular shift and/or translational shift of state point data of the route B such that localization of nearby objects along route B aligns with localization of the same objects during navigation of the global route 302. The scan match transformation comprises a transformation of the route key B′ data along at least one of (x, y, θ) axis which causes the objects localized in key B′ to match the objects of the global key.

According to at least one non-limiting exemplary embodiment, the discrepancies between individual scans of objects between the global key and transformed key B′ may be compared to a threshold, wherein discrepancies below a threshold may be determined to be negligible and/or discrepancies above a threshold may be determined to be caused by changes in an environment or substantial human error and may require the operator to input location 402 and/or direction 404 again or navigate the global route a second time.

Block 712 comprises the controller 118 storing the scan matched key B′, denoted hereinafter as B″, and corresponding route B data (e.g., state points, localization data, etc.), into memory 120.

Block 714 comprises the controller 118 correcting the starting direction and location of the base B based on the scan match transformation. The scan match transformation denotes translational and/or angular discrepancies between the actual location and starting direction of base B and the user input location and direction of base B. Accordingly, the location of the base B may be corrected for future transformations of other route keys which originate at base B as the controller 118 may store in memory 120 an accurate position of the base B with respect to the base A. Using the corrected location of the base B, based on the scan match transformation, later transformations of disjointed map data (e.g., from other routes of base B) to a global map may be performed using a linear transformation similar to the transformation of block 706.

Additionally, during each subsequent navigation of the route B a new key B may be generated as the robot 102 executes the route B based on the transformed and scan matched key B stored in memory 120, wherein data from the new key B and transformed and scan matched key B may be substantially similar. Subsequent scan matches may comprise substantially smaller discrepancies 606 than the first scan matching in blocks 708-710 and may be performed to further enhance the accuracy of the global map. Similarly, all other routes that originate from base B may now be redefined with respect to the base A origin of the global key.

According to at least one non-limiting exemplary embodiment, a robot 102 may continue to navigate routes beginning from base B using local coordinates defined with respect to an origin B of base B. Navigation of these routes may produce respective route keys which may be transformed or aligned with a global map of an environment of the robot 102 upon user request. That is, upon generation of the global or merged map, the robot(s) 102 are not required to utilize the redefined coordinates for navigation.

Advantageously, storing a plurality of transformed keys within memory 120 may enable the controller 118 to recall route data stored using the keys for later recollection. For example, a human operator may prompt a robot 102 to display all routes it has navigated from all base stations A and B. Accordingly, the controller 118 may utilize data stored within the plurality of transformed keys in memory 120 to generate a single map comprising a plurality of routes starting at different base stations and defined about a single origin. Defining the plurality of routes with respect to a single origin may additionally provide a human user with more accurate information as to where and when the robot 102 navigated a route corresponding to a key, accurate localization of objects, and easier task assignment to the robot 102. For example, an operator may desire a robot 102 to navigate a route B after navigating a route A. The robot 102 may utilize the method 700 to localize base B with respect to the base A and navigate to the base B of route B (now properly defined with respect to the origin of route A) without the need for the operator to move the robot to the origin of route B as the origin of route B is already defined within the reference coordinates of A (i.e., the reference coordinates the robot 102 is already following). As a second example, an operator may desire to view the area covered by all floor cleaning robots 102 within a store to determine how much floor space has been cleaned, and the robots 102 may be executing different routes originating at different starting locations.

FIG. 8 illustrates an exemplary home base 802 according to an exemplary embodiment. Home base 802 may comprise a quick response (QR) code, or similar salient feature, recognizable by a robot 102. The robot 102 may detect the home base 802 using sensor units 114 such as, for example, using imaging cameras. Upon detection of the home base 802, the robot 102 may define the location of the home base 802 as an origin for a route beginning and ending at the home base 802. Accordingly, the home base 802 illustrated in FIG. 8 may be illustrative of home bases 210 illustrated in FIG. 2 above. A plurality of home bases 802 may be located throughout an environment, wherein the systems and methods of the present disclosure may be utilized to redefine a plurality route keys generated with respect to the plurality of home bases 802 to an origin located at a single home base 802. It is appreciated that a home base 802 may be implemented using a plurality of landmark types such as, for example, painted indicators on a wall/floor, infrared beacons, recognizable landmarks (e.g., furniture), charging station, and the like, wherein the use of a QR code is not intended to be limiting.

FIG. 9A is an exemplary illustration of the method 700 for merging at least three disjointed maps 902-A, 902-B, 902-C, according to an exemplary embodiment. One skilled in the art will appreciate that more than three disjointed maps may be merged together. Alternatively, at least two disjointed maps may be merged together. The present discussion regarding merging at least three disjointed maps is not limiting to the present inventive concepts disclosed herein. Each disjointed map 902-A, 902-B, and 902-C may correspond to route and object localization data observed by a robot 102 navigating respective routes 204-A, 204-B, and 204-C shown in FIG. 2. An operator may have completed a global route 302 to produce a global key comprising route and object localization data shown by map 904. One skilled in the art would appreciate that the disjointed maps 902-A, 902-B, and 902-C may be generated by different robots independent of each other, and not a single robot. Further, one skilled in the art will appreciate that merging of the disjointed maps 902-A, 902-B, and 902-C may be done by an external processor.

The operator may provide a starting location 402 and starting direction 404 with some error. A distance between origin 202-A and the input 402 may provide (x, y) parameters of measurement 406 and the angular difference between a 0° angle of origin 202-A and the angle of direction 404 may provide the (4) parameter. Accordingly, the transformation illustrated in the table of FIG. 5 may be applied to the disjointed map 902-B, as shown next in FIG. 9B. It is appreciated that disjointed map 902-A and the global map 904 both comprise the same origins and require no further transformation.

FIG. 9B illustrates a transformed disjointed map 902-B overlaid onto the global map 904 based on the user-provided inputs 402 and 404, according to an exemplary embodiment. Origin 202-B is illustrated on the global map 904 at its true position for reference along with a true starting direction 910 of route 204-B for clarity, however, it is appreciated that neither of these true locations or directions is known to the controller 118 of the robot 102 prior to performing a scan matching. Point 402 is the location where the operator provided input to GUI 400 as to the location of the origin 202-B which, as illustrated, is incorrect. Further, the angular difference between direction 404 of FIG. 9A and the actual starting direction of route 204-B causes angular misalignment. The true starting direction of route 204-B is perfectly horizontal (with respect to the page), however the direction 404 provided in FIG. 9B is angled downwards in this exemplary embodiment. Following method 700, a scan match transformation between objects 906 (grey) of the global map 904 and objects 908 (hashed) of the map 902-B may be determined. The objects 906 and 908 may be represented by point clouds, wherein the scan matching may utilize a nearest neighboring algorithm to match points of the point cloud which represent the same objects. The scan matching algorithm may determine a (x, y, θ) change to the map 902-B which minimizes the discrepancy between the map 902-B and the global map 904.

FIG. 9C illustrates map 902-B aligned with a global map 904 based on a scan match transformation, according to an exemplary embodiment. The scan match transformation may determine that the starting point 402 and starting direction 404 differ from an actual starting location 202-B and starting direction 910 by an amount equal to the scan match transformation (i.e., proportional to discrepancies 606 of FIG. 6). As shown, both maps 904 and 902-B comprise localized objects that overlap. Accordingly, route 204-B may now be localized onto the global map 904. Some objects 906 (on the left side of the map illustrated) not sensed by sensor units 114 during navigation of route 204-B are not considered during the scan matching process.

FIG. 9D illustrates all three maps 902-A, 902-B, 902-C overlaid on the global map 904 (outlined using dotted lines), according to an exemplary embodiment. The same method illustrated in FIG. 9A-C above for aligning the map 902-B with the global map 904 may be similarly applied to map 902-C. According to at least one non-limiting exemplary embodiment, user interface units 112 of a robot 102 may display a global map, similar to the one illustrated in FIG. 9D, to a user upon being prompted to, for example, display all routes navigated by robots within the entire environment.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated for carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least”; the term “such as” should be interpreted as “such as, without limitation”; the term ‘includes” should be interpreted as “includes but is not limited to”; the term “example” is used to provide exemplary instances of the item in discussion, not an exhaustive or limiting list thereof, and should be interpreted as “example, but without limitation”; adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A method for merging multiple routes, comprising:
navigating a robotic device along a global route to generate a global route key, the global route being defined from a first origin and comprising a closed loop, the closed loop encompassing an entire environment of a second route and a second origin point of the second route;
defining, relative to the first origin, a starting orientation and position of the robotic device at the second origin point of the second route based on a user input; and
generating a new route key for the second route by applying a transformation to a second route key of the second route based on the determined starting orientation and position of the second origin point, the new route key comprising the second route data redefined with respect to the first origin.

2. The method of claim 1, further comprising:
determining discrepancies between localization of objects between the global route key and the new route key during subsequent navigation of the second route; and
applying a scan match transformation to the new route key based on the discrepancies between the localization data of objects of the new route key and the global route key.

3. The method of claim 2, wherein:
the scan match transformation is performed by one or more sensors based on discrepancies between the localization data of individual scans of the global route key and scans collected during subsequent navigation of the new route key.

4. The method of claim 2, further comprising:
imposing an error threshold on the discrepancies between the localization of the objects between the global route key and the new route key, wherein errors exceeding the error threshold is not applied to the scan match transformation.

5. The method of claim 2, further comprising:
generating a computer readable map of the entire environment comprising the global route and the second route defined with respect to the first origin using the new route key and global route key.

6. A non-transitory computer readable storage medium comprising a plurality of computer readable instructions stored thereon that when executed by at least one processing device, configure the at least one processing device to,
generate a global route key during navigation of a global route by a robotic device, the global route being defined from a first origin and comprising a closed loop, the closed loop encompassing an entire environment and a second origin point of a second route;
define, relative to the first origin, a starting orientation and position of the robotic device at the second origin point of the second route based on a user input; and
generate a new route key for the second route by applying a transformation to a second route key of the second route based on the determined starting orientation and position of the second origin point, the new route key comprising the second route data redefined with respect to the first origin.

7. The non-transitory computer readable storage medium of claim 6, wherein the at least one processing device is further configurable to execute the plurality of computer readable instructions to,
determine discrepancies between localization of objects between the global route key and the new route key during subsequent navigation of the second route, and
apply a scan match transformation to the new route key based on the discrepancies between the localization data of objects of the new route key and the global route key.

8. The non-transitory computer readable storage medium of claim 7, wherein,
the scan match transformation is performed by one or more sensors based on discrepancies between the localization data of individual scans of objects between the global route key and new route key.

9. The non-transitory computer readable storage medium of claim 7, wherein the at least one processing device is further configurable to execute the plurality of computer readable instructions to,
impose an error threshold on the discrepancies between the localization of the objects between the global route key and the new route key, wherein errors exceeding the threshold is not be applied to the scan match transformation.

10. The non-transitory computer readable storage medium of claim 7, wherein the at least one processing device is further configurable to execute the plurality of computer readable instructions to,
generate a computer readable map of the environment comprising the global route and second route defined with respect to the first origin using the scan matched new route key and global route key.

11. A robotic device, comprising:
a memory comprising a plurality of computer readable instructions stored thereon;
at least one processing device configurable to execute the plurality of computer readable instructions to,
generate a global route key during navigation of a global route by a robotic device, the global route being defined from a first origin and comprising a closed loop, the closed loop encompassing an entire environment and a second origin point of a second route;
define, relative to the first origin, a starting orientation and position of the robotic device at the second origin point of the second route based on a user input; and
generate a new route key for the second route by applying a transformation to a second route key of the second route based on the determined starting orientation and position of the second origin point, the new route key comprising the second route data redefined with respect to the first origin.

12. The robotic device of claim 11, wherein the at least one processing device is further configurable to execute the plurality of computer readable instructions to,
determine discrepancies between localization of objects between the global route key and the new route key during subsequent navigation of the second route; and
apply a scan match transformation to the new route key based on the discrepancies between the localization data of objects of the new route key and the global route key.

13. The robotic device of claim 12, wherein,
the scan match transformation is performed by one or more sensors based on discrepancies between the localization data of individual scans of the global route key and new route key.

14. The robotic device of claim 12, wherein the at least one processing device is further configurable to execute the plurality of computer readable instructions to,
impose an error threshold on the discrepancies between the localization of the objects between the global route key and the new route key, wherein errors exceeding the error threshold may not be applied to the scan match transformation.

15. The robotic device of claim 12, wherein the at least one processing device is further configurable to execute the plurality of computer readable instructions to,
generate a computer readable map of the environment comprising the global route and second route defined with respect to the first origin using the scan matched new route key and global route key.

16. A method for merging multiple maps, comprising:
merging a first map and a second map to form a single global map, the global map representing first and second routes traveled by one or more robotic devices, wherein,
the first map comprising the first route and object localization data, the first route and the localization data are collected by one or more sensors on a first respective robotic device while traveling along the first route, and
the second map comprising the second route and object localization data, the second route and object localization data are collected by one or more sensors on a second respective robotic device while traveling along the second route.

17. The method of claim 16, wherein the second route is different from the first route and traveled independent of the first route.

18. The method of claim 16, further comprising:
transforming the first and second maps prior to the merging of the first and second maps to form the global map, the transformation of the first and second maps being with respect to a global route.

19. The method of claim 18, wherein the global route comprises a plurality of state points defined with respect to an origin of a base in an environment traveled by the robotic device.

20. The method of claim 16, wherein the merging of the first and second maps is performed by a server external to the robotic device.
